(19) United States
(12) Patent Application Publication
(10) Pub. No.: US 2019/0219403 A1
(43) Pub. Date: Jul. 18, 2019

(54) INDOOR POSITIONING TECHNIQUE AND INFORMATION PUSHING SYSTEM, METHOD AND DEVICE BASED THEREON, AND TERMINAL

(71) Applicants: COMBA TELECOM SYSTEMS (CHINA) LTD., Guangzhou, Guangdong (CN); COMBA TELECOM SYSTEMS (GUANGZHOU) LTD., Suangzhou, Guangdong (CN); COMBA TELECOM TECHNOLOGY (GUANGZHOU) LTD., Suangzhou, Guangdong (CN); TIANJIN COMBA TELECOM SYSTEMS LTD., Tianjin (CN)

(72) Inventor: Yingtian HU, Guangzhou, Guangdong (CN)

(21) Appl. No.: 16/327,637

(22) PCT Filed: Jul. 13, 2017
(86) PCT No.: PCT/CN2017/092858

§ 371 Date: Feb. 22, 2019

(30) Foreign Application Priority Data
Aug. 24, 2016 (CN) 201610710387.9

(51) Int. Cl. G01C 21/20; G01S 5/02; H04W 4/33; H04L 29/08; H04W 4/029

(52) U.S. Cl. CPC G01C 21/206; G01S 5/02; H04W 4/029; H04L 67/18; H04W 4/33

(57) ABSTRACT

Disclosed are an indoor positioning technique and an information pushing system, method and device based thereon, and a terminal. The system comprises: an intelligent terminal subsystem, an indoor positioning subsystem, an application server subsystem, and a friend-matching server subsystem. The intelligent terminal subsystem has a wireless signal transceiving function and an operating system platform capable of installing an application. The indoor positioning subsystem realizes, on the basis of a wireless signal, and according to a certain algorithm, precise indoor positioning of a user. The application server subsystem is used to receive and perform processing and information submission on service requests. The matching server subsystem is used to push a friend list at a position of the user to a user application list in the intelligent terminal subsystem.

This application is a National Stage of International Application No. PCT/CN2017/092858, filed Jul. 13, 2017, which claims priority to Chinese Patent Application No. 201610710387.9, filed Aug. 24, 2016, both of which are hereby incorporated by reference in their entireties.

### FIELD

The present invention relates to the field of Internet technologies, and particularly to an indoor positioning system and method, a back-end device, a terminal, and a system and method for pushing information based upon the indoor positioning system and method.

### BACKGROUND

As Location Based Services (LBS) and Online to Offline (020) services are developing constantly, positioning technologies have been significantly favored and developed rapidly in recent years. A location based service is a value-added service in which positional information (geographical coordinates or earth coordinates) of a user of a mobile terminal is obtained through a radio communication network (e.g., a Global System for Mobile communications (GSM) network or a Code Division Multiple Access (CDMA) network) of a telecommunication mobile operator, or through an external positioning system (e.g., the Global Positioning System (GPS)), and the user is provided with a corresponding service under the support of a Geographic Information System (GIS) platform. The traditional GPS-based outdoor positioning technologies have been well developed and come to wide applications, but the indoor positioning technologies where the positioning technologies terminate have been underdeveloped.

As the mobile Internet is developing, and smart phones are being popularized, third applications (APPs), and particularly social APPs, of the smart phones are also developing rapidly.

High precision of positioning is required for a social friend-making APP, and if a position of a user can be provided precisely, then the quality and the success ratio of making a friend will be greatly improved. However some existing technologies and methods are, GPS-based, Assisted GPS-based, or Bei Dou-based positioning methods with positioning precision which is generally more than ten meters, which is far away from the high precision of positioning required in a real application.

The GPS of USA, the Bei Dou satellite navigation system of China, and other global satellite navigation systems have been widely applied in present society; and these global satellite navigation systems generally position an object in space under the three-sphere theorem, that is, distances between a plurality of satellites and a moving object are measured, and three-dimension coordinates of the moving object are calculated, according to the distances and known precise real-time positional information of the satellites, where the positioning precision of both the GPS and the Bei Dou satellite navigation system is ten meters.

However indoor positioning is impossible with the global satellite navigation systems. The reasons are as following: civil precision of the global satellite navigation systems is ten meters, which is too low for indoor positioning; there is such low power of a satellite signal that the signal can not penetrate a building or another solid obstacle, and thus may be blocked from positioning; and there is no indoor map in databases of the global satellite navigation systems.

A GIS-based friend-making system is proposed in Chinese Patent application No. CN200810167140, entitled “A friend-making system and method, and a friend-making server”; and in this positioning system, only longitudinal and latitudinal information of a user can be provided, that is, only a building (e.g., China Beijing World Towers) can be positioned at positioning precision of more than ten meters, but a specific room at a specific floor in the specific building (e.g., Room 401, Floor 4 in China Beijing World Towers) can not be positioned at positioning precision of three to five meters.

In the technical solution proposed in Chinese Patent application No. CN200610060380, entitled “An interactive friend-making method with precision positioning”, a user is positioned through the GPS, and the user makes a friend interactively over a pre-created network based upon the positional information. Although this technical solution can provide a satisfactory location service function, the GPS-based solution can not obviate the problems of insufficient GPS positioning precision, and a signal being blocked from indoor positioning, so there is no high precision required in indoor positioning.

Accordingly the GPS, the Bei Dou, and other positioning systems have low precision, a significant error, and other disadvantages in an indoor environment, so it is desirable to provide a new indoor positioning system and information pushing system so as to provide high precision required in indoor positioning.

### SUMMARY

In view of the problems in the prior art of low precision and accuracy of indoor positioning, embodiments of the invention provide a precise indoor positioning system, and an information pushing system based upon precise indoor positioning. In order to attain the same object, embodiments of the invention further provide a precise indoor positioning method, an information pushing method, a back-end device, and a terminal.

In order to attain the object above, an embodiment of the invention provides an information pushing system based upon precise indoor positioning, and the information pushing system includes an intelligent terminal sub-system, an indoor positioning sub-system, an APP server sub-system, and a friend-making server sub-system, where the intelligent terminal sub-system is connected with both the indoor positioning sub-system and the APP server sub-system, and the APP server sub-system is connected with the friend-making server sub-system, where: the intelligent terminal sub-system has a function of transmitting and receiving a radio signal, and includes an open operating system platform on which an APP can be installed. For example, the radio signal includes a Wireless Fidelity (WiFi: an IEEE 802.11-based wireless local area network) signal, a Bluetooth signal, a ZigBee (an IEEE 802.15.4-based low-power local area network protocol) signal, a 2G/3G/4G signal, a future 5G signal, etc. The function of transmitting and receiving a radio signal refers to a function of interacting with the indoor positioning sub-system for precise indoor positioning.

Also the intelligent terminal sub-system includes an open operating system platform on which an intelligent APP can be installed. For example, common open operating system platforms include Apple iOS, Android, Microsoft Windows Phone, and other operating systems. For example, typical intelligent terminal sub-systems include a smart phone, a Portable Android Device (PAD), a smart wearable device (a smart watch, a smart wrist ring, etc.), a smart TV set, etc.

Unlike the existing GPS or A-GPS-based positioning methods, the indoor positioning sub-system measures some parameters of a received radio wave based upon a radio signal (a Bluetooth signal, a WiFi signal, a 2G/3G/4G signal, etc.), precisely measures a geographical position of some mobile terminal or moving person at some instance of time using some algorithm, and precisely positions an indoor user of the intelligent terminal sub-system according to pre-stored database and map information.

The APP server sub-system is configured to receive service requests and feedback information (e.g., registration of an APP user, logging-on of the APP user, deregistration of the APP user, a friend-making request of the APP user, and other request information) of a user terminal transmitted by the intelligent terminal sub-system, to process these service requests, and to feed some information, e.g., a success in making a friend by the APP user back to the intelligent terminal sub-system. The APP server sub-system is also configured to transmit a part of the service requests of the user of the intelligent terminal sub-system (e.g., a friend-making request of the APP user) to the friend-making server sub-system, so that the friend-making server sub-system processes these service requests, and transmits results of processing the requests to the user terminal of the intelligent terminal sub-system through the APP server sub-system.

The friend-making server sub-system is configured to make back-end large-data calculation and statistics according to the request information of a list of friends, transmitted from the intelligent terminal sub-system, and the positional information of the user obtained as a result of interaction between the intelligent terminal sub-system and the indoor positioning sub-system; and to push the list of friends at a position where the user is located, into a list of APPs of the user of the intelligent terminal sub-system 101 through the APP server sub-system, so that the user terminal can obtain friend information at the position where the user terminal is located.

In the embodiments above of the invention, the invention provides an embodiment of the invention provides an information pushing system based upon precise indoor positioning to which an indoor positioning technology and an indoor positioning sub-system are introduced to thereby address the problems of low precision, a significant error of the GPS, Bei Dou, and other positioning systems in an indoor environment. After the position of a terminal user is determined precisely, information is pushed precisely in an individualized manner according to a demand of the terminal user of an intelligent terminal sub-system for making a friend, and presented on an APP of the terminal user, through a friend-making server sub-system, an APP server sub-system, etc. Moreover the individual APP server sub-system can be separated, and the inventive method can be applicable to a third-party friend-making APP to thereby improve the extensibility, compatibility, and openness of the invention, and improve the applicability of the invention so as to greatly improve the adaptability and competitiveness of the system.

### BRIEF DESCRIPTION OF THE DRAWINGS

In order to make the technical solutions according to the embodiments of the invention more apparent, the drawings to which reference is to be made in the description of the embodiments will be introduced below in details, and apparently the drawings to be described below illustrate only some embodiments of the invention, and those ordinarily skilled in the art can further derive other drawings from these drawings without any inventive effort.

FIG. 1 is a schematic structural diagram of an information pushing system according to an embodiment of the invention.

FIG. 2 is a schematic diagram of modules in an indoor positioning sub-system according to an embodiment of the invention.

FIG. 3 is a schematic flow chart of interaction between an intelligent terminal sub-system and an indoor positioning sub-system according to an embodiment of the invention.

FIG. 4 is a schematic diagram of positioning APs deployed at a plurality of floors in a same building according to an embodiment of the invention.

FIG. 5 is a schematic flow chart of interaction in an information pushing system according to an embodiment of the invention.

FIG. 6 is a schematic structural diagram of an intelligent terminal according to an embodiment of the invention.

FIG. 7 is a schematic structural diagram of an APP back-end device according to an embodiment of the invention.

FIG. 8 is a schematic structural diagram of a friend-making back-end device according to an embodiment of the invention.

FIG. 9 is a schematic structural diagram of an indoor positioning terminal according to an embodiment of the invention.

### DETAILED DESCRIPTION OF THE EMBODIMENTS

The technical solutions according to the embodiments of the invention will be described below clearly and fully with reference to the drawings in the embodiments of the invention; and apparently the embodiments to be described below are only a part but not all of the embodiments of the invention. Based upon the embodiments here of the invention, all the other embodiments which can occur to those ordinarily skilled in the art without any inventive effort shall fall into the scope of the invention.

The embodiments of the invention provide an information pushing system and method based upon precise indoor positioning; with an introduction of an indoor positioning sub-system and a friend-making service sub-system, corresponding flows are standardized, and an independent APP server sub-system is separated; and this inventive method can be applicable to a third-party friend-making APP to thereby improve the extensibility, compatibility and openness of the invention.

The embodiments of the invention will be described below.

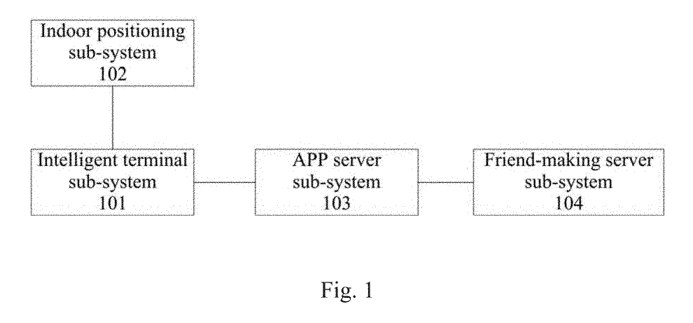

As illustrated in FIG. 1 which is a schematic structural diagram of an information pushing system based upon precise indoor positioning according to an embodiment of the invention. The information pushing system according to the embodiment includes an intelligent terminal sub-system 101, an indoor positioning sub-system 102, an APP server sub-system 103 and a friend-making server sub-system 104, where the intelligent terminal sub-system 101 is connected with both the indoor positioning sub-system 102 and the APP server sub-system 103, and the APP server sub-system 103 is connected with the friend-making server sub-system 104.

The intelligent terminal sub-system 101 has a function of transmitting and receiving a radio signal. For example, common radio signals include a Wireless Fidelity (WiFi: an IEEE 802.11-based wireless local area network) signal, a Bluetooth signal, a ZigBee (an IEEE 802.15.4-based low-power local area network protocol) signal, a 2G/3G/4G signal, a future 5G signal, etc. The function of transmitting and receiving a radio signal refers to a function of exchanging information with the indoor positioning sub-system 102 for precise indoor positioning.

Also the intelligent terminal sub-system 101 includes an open operating system platform on which an intelligent APP can be installed. For example, common open operating system platforms include Apple iOS, Android, Microsoft Windows Phone, and other operating systems. For example, typical intelligent terminal sub-systems include a smart phone, a Portable Android Device (PAD), a smart wearable device (a smart watch, a smart wrist ring, etc.), a smart TV set, etc.

Unlike the existing GPS or A-GPS-based positioning methods, the indoor positioning sub-system 102 measures some parameters of a received radio signal based upon the radio signal (a Bluetooth signal, a WiFi signal, a 2G/3G/4G signal, etc.), precisely measures a geographical position of some mobile terminal or moving person at some instance of time using some algorithm, and precisely positions an indoor user of the intelligent terminal sub-system 101 according to pre-stored database and map information.

In the existing positioning solutions, only longitudinal and latitudinal information of a user can be provided, and the user can only be positioned in a building (e.g., China Beijing World Towers) at positioning precision of more than ten meters, but a specific room at a specific floor in the specific building (e.g., Room 401, Floor 4 in China Beijing World Towers) can not be positioned at positioning precision of three to five meters. The indoor positioning sub-system 102 in the inventive method can enable indoor positioning at positioning precision of three to five meters.

The APP server sub-system 103 is configured to receive service requests and feedback information (e.g., registration of an APP user, logging-on of the APP user, deregistration of the APP user, a friend-making request of the APP user, and other request information) of a user terminal transmitted by the intelligent terminal sub-system 101, to process these service requests, and to feed some information, e.g., a success in making a friend by the APP user, back to the intelligent terminal sub-system 101. The APP server sub-system 103 is also configured to transmit a part of the service requests of the user terminal of the intelligent terminal sub-system 101 (e.g., a friend-making request of the APP user) to the friend-making server sub-system 104, so that the friend-making server sub-system 104 processes these service requests, and transmits results of processing the requests to the user terminal of the intelligent terminal sub-system 101 through the APP server sub-system 103.

In this embodiment, the intelligent terminal sub-system 101 exchanges information with the indoor positioning sub-system 102 in response to a positioning request of the friend-making server sub-system 104, and determines positional information of the terminal user, and transmits the positional information to the friend-making server sub-system 104.

The positional information of the terminal user here includes not only longitudinal and latitudinal information of the user, but also a specific building and floor information to thereby further improve the precision of positioning.

The friend-making server sub-system 104 is configured to make back-end large-data calculation and statistics, according to request information of a list of friends transmitted from the intelligent terminal sub-system 101, and the positional information of the user obtained as a result of interaction between the intelligent terminal sub-system 101 and the indoor positioning sub-system 102; and to push the list of friends at a position where the user is located, into a list of APPs of the user of the intelligent terminal sub-system 101 through the APP server sub-system 103, so that the user terminal can obtain friend information at the position where the user terminal is located.

Furthermore the user of the user terminal of the intelligent terminal sub-system 101 can make a friend as needed according to the pushed friend information around the position where he or she is located, to thereby greatly improve the success ratio of making a friend. The friend-making server sub-system 104 can further push user-customized friend information as needed by the user of the intelligent terminal sub-system 101, or by making a large-data analysis, and for example, can push heterosexual friend information to the user according to his or her gender.

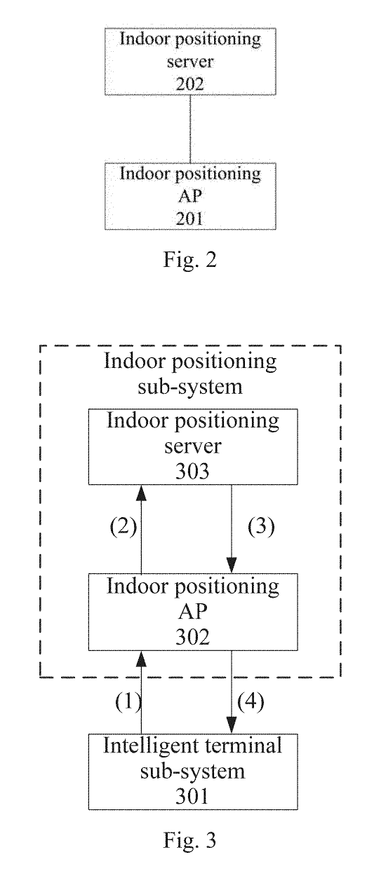

FIG. 2 illustrates a schematic diagram of components of the indoor positioning sub-system according to an embodiment of the invention; and as illustrated in FIG. 2, the indoor positioning sub-system 102 includes indoor positioning Access Points (APs) 201 and an indoor positioning server 202.

Here each indoor positioning AP 201 is generally a small base station with a function of transmitting and receiving a radio signal, which can generate, transmit, and receive a radio signal; has output power ranging from 10 mw to 200 mW (mw: milliwatt), and a coverage area ranging from 10 to 100 meters; and generally includes a WiFi small base station, a Bluetooth small base station, a 2G/3G/4G/5G small base station, a ZigBee small base station, etc.

Here the indoor positioning server 202 generally has an indoor positioning algorithm function, and determines the precise indoor position of the terminal user through calculation and making a decision using the algorithm according to field intensity information and fingerprint information of the terminal user, and stored map information. The indoor positioning server 202 is generally a general-purpose server, e.g., a Windows X86 server, etc.

Generally the indoor positioning server 202 triggers the intelligent terminal sub-system 101 of the target terminal user to be connected with an indoor positioning AP 201, in response to a positioning request reported by the indoor positioning AP 201, obtains the field intensity information and the fingerprint information of the corresponding terminal user, processes the collected data using some algorithm, matches the processed data with the stored map information, a fingerprint information base, etc., makes a decision, and determines the positional information of the terminal user, thus positioning the terminal user precisely.

Each indoor positioning AP 201 is generally deployed in two modes. In one mode, it is provided by an indoor positioning server provider, where the indoor positioning server provider deploys the indoor positioning AP 201 and the indoor positioning server 202; and in the other mode, it is deployed by an operator, where the operator generally deploys indoor commercially-available APs to provide a coverage area of radio signals, and the indoor positioning server provider can define a related interface and protocol, for transmitting and receiving a signal, with the operator, obtain information about terminal users residing with the AP, and upload the information to the indoor positioning server 202 deployed by the indoor positioning server provider, so that the indoor positioning server 202 makes a decision, and determines the positional information of the terminal user, and feeds the positional information back to the user terminal of the intelligent terminal sub-system 101 through the indoor positioning AP 201.

An indoor positioning technology using a Bluetooth small base station can be the iBeacon technical solution from Apple Corporation. Apple Corporation proposed an indoor positioning system using a low-power Bluetooth module in 2013, i.e., the iBeacon solution. A distance in a topology of the indoor positioning APs 201 is calculated using a model in which the intensity of a radio frequency field attenuates over a distance. Bluetooth small base stations are set up so that the indoor positioning APs 201 can form a communication area with a radius of 50 m, and all the devices in the area can transmit information using the low-power Bluetooth technology. The indoor positioning server 202 is provided with a related algorithm in software, and can determine the position precisely according to the field intensity information of the terminal user fed back by the indoor positioning APs 201, and output the position decision result. In the iBeacon solution applied to indoor positioning, the position of the user can be perceived as Far, Near, or Immediate at positioning precision of a decimeter under the triangular positioning theorem.

There are two indoor positioning solutions using WiFi and 2G/3G/4G/5G small base stations, where in one solution, the terminal user is triangularly positioned precisely in a differential algorithm according to radio signal intensities of a mobile device and three radio network access points; and in the other solution, a plurality of signal intensities of specific positional points (“fingerprint” information) are recorded in advance, and a signal intensity of a newly joining device is compared with a database of user fingerprints to determine the position thereof (“fingerprint” positioning). There may be precision of three to five meters in such an indoor positioning method. Two new fingerprint positioning methods are proposed in Chinese Patent No. 201310348083.9, entitled “A fingerprint positioning method and server”, and Chinese Patent No. 201310348033.0, entitled “A fingerprint positioning method and server”, where a terminal user is positioned precisely.

FIG. 3 illustrates a schematic flow chart of interaction between an intelligent terminal sub-system and an indoor positioning sub-system according to an embodiment of the invention. The flow includes the following operations.

(1) The intelligent terminal sub-system 301 resides in a cell of an indoor positioning AP 302, and transmits radio signal intensity information, fingerprint information, etc., to the indoor positioning AP 302.

(2) The indoor positioning AP 302 feeds back the received radio signal intensity information, fingerprint information, etc., to an indoor positioning server 303, and the indoor positioning server 303 receives the radio signal intensity information, the fingerprint information, etc., fed back by three indoor positioning APs 302, processes the information using some technology (e.g., the iBeacon technology) and algorithm, and determines a precision position of a terminal user according to map information or fingerprint information stored on the server.

(3) The indoor positioning server 303 transmits the determined precision position of the terminal user to the indoor positioning AP 302.

(4) The indoor positioning AP 302 further transmits the determined precision position of the terminal user to the intelligent terminal sub-system 301, thus positioning the indoor terminal user precisely.

In the embodiment of the invention, the precise indoor positioning system can position a specific floor of a building precisely so that the information pushing system according to the embodiment of the invention can push precisely the list of friends and the friend information at the position where the terminal user is located.

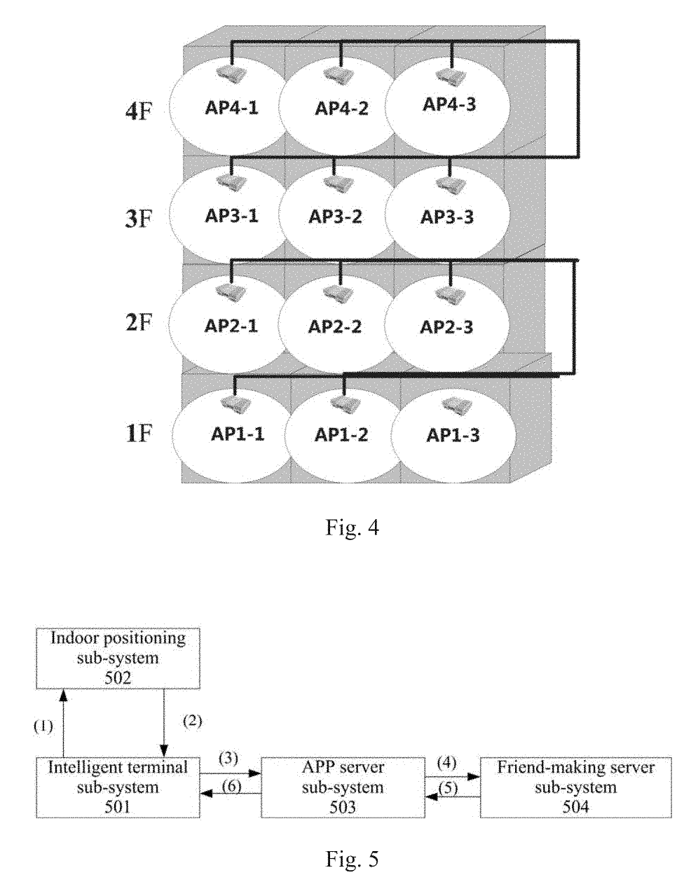

FIG. 4 illustrates a schematic diagram of positioning APs deployed at a plurality of floors in the same building according to an embodiment of the invention. In the embodiment of the invention, an intelligent terminal user, e.g., a specific floor where the user is located, can be positioned precisely. In order to position the terminal user precisely, the following operations are performed.

(1) Floor information of a specific building is also included in the map information, and stored into the indoor positioning server 303 in a form of electronic map vector data.

(2) The respective indoor positioning APs 302 at the respective floors are labeled individually, and label numbers of the respective APs are recorded and stored into the indoor positioning server 303.

(3) For indoor positioning, the indoor positioning AP 302 (e.g., a WiFi small base station, a Bluetooth small base station, a 2G/3G/4G/5G small base station, a ZigBee small base station, etc.) obtains residing information about the user terminal, and positions the terminal user under a specific AP preliminarily using some technology and algorithm.

(4) The indoor positioning AP 302 transmits positional information positioned preliminarily which includes a label number corresponding to the indoor positioning AP 302, to the indoor positioning server 303.

(5) The indoor positioning server 303 maps and matches the positional information positioned preliminarily, and the label number of the indoor positioning AP, transmitted by the indoor positioning AP 302 with the electronic map vector data in a database to thereby determine precisely the precision position of the terminal user, and outputs longitudinal and latitudinal information, floor information, specific indoor positional information, etc., of the terminal user to the intelligent terminal sub-system 301.

In FIG. 4, for some specific building, the indoor positioning APs 302 are positioned respectively as AP1-1, AP1-2, AP1-3, etc., at different floors, and provided with different label numbers so that they can be distinguished from each other by the indoor positioning server 303 to thereby position the indoor terminal user precisely.

The user terminal of the intelligent terminal sub-system initiates a request for updating information about online friend-making, in two modes, where in one mode, the user terminal initiates a friend-making request on an APP on its own initiative, requests the friend-making server sub-system 104 for transmitting a list of friends or information about friends around a terminal user of the user terminal, and updates in real time the list of friends or the information about friends into the APP of the user, and this mode can be referred to as an active pushing mode; and in the other mode, other than initiating by the user terminal a request for updating information about online friend-making, on its own initiative, the APP performs periodically polling, requests the friend-making server sub-system 104 periodically (e.g., at an interval of 30 minutes) for a list of friends or information about friends around the terminal user, and updates in real time the list of friends or the information about friends into the APP of the user, and this mode can be referred to as a passive pushing mode.

There is a same interaction flow in the active pushing mode and the passive pushing mode, and the interaction flow will be described below in the active pushing mode. FIG. 5 illustrates a schematic flow chart of interaction in an information pushing system according to an embodiment of the invention, and the flow includes the following operations.

(1) A user terminal of an intelligent terminal sub-system 501 transmits a positional information request carrying radio signal intensity information, fingerprint information, or other information, of the terminal user to an indoor positioning sub-system 502 on its own initiative.

(2) The indoor positioning sub-system 502 receives the position request, the radio signal intensity information, the fingerprint information, or the other information, of the intelligent terminal sub-system 501, processes the request and the information using a positioning technology, outputs a precise geographical position of the terminal user, and transmits the information to the intelligent terminal sub-system 501.

(3) The user terminal of the intelligent terminal sub-system 501 initiates a request for updating information about online friend-making, which carries the precise positional information of the terminal user, and transmits the request, and the precise positional information of the terminal user to an APP server sub-system 503.

(4) The APP server sub-system 503 transmits the request for updating information about online friend-making, initiated from the user terminal of the intelligent terminal sub-system 501 on its own initiative, and the precise positional information of the terminal user, to a friend-making server sub-system 504.

(5) The friend-making server sub-system 504 makes back-end large-data calculation and statistics, and transmits a list of friends at the position where the user is located, to the APP server sub-system 503.

(6) The APP server sub-system 503 receives the list of friends, at the position where the user is located, transmitted from the friend-making server sub-system 504, transmits the information to the intelligent terminal sub-system 501, and updates in real time the information into the APP of the user.

The user of the intelligent terminal sub-system 501 can also make a friend as needed according to the pushed friend information around the position where he or she is located, to thereby greatly improve the success ratio of making a friend. The friend-making server sub-system 504 can also push user-customized friend information as needed by the user of the intelligent terminal sub-system 501, or by making a large-data analysis, and for example, can push heterosexual friend information to the user according to his or her gender.

The technical solution according to the invention can also be applicable to a third-party developed APP, e.g., common friend-making applications including QQ, WeChat, MOMO, Beauty-dating, etc.

In summary, the embodiments of the invention provides an information pushing system based upon precise indoor positioning to which an indoor positioning technology and an indoor positioning sub-system are introduced to thereby address the problems of low precision, a significant error of the GPS, Bei Dou, and other positioning systems in an indoor environment. Some parameter of a received radio wave is measured, and the geographical position of some mobile terminal or moving person at some instance of time is determined precisely using some algorithm. After the position of a terminal user is determined precisely, information is pushed precisely in an individualized manner according to a demand of the terminal user of an intelligent terminal sub-system for making a friend, and presented on an APP of the terminal user, through a friend-making server sub-system, an APP server sub-system, etc. Moreover the individual APP server sub-system can be separated, and the inventive method can be applicable to a third-party friend-making APP to thereby improve the extensibility, compatibility, and openness of the invention, and improve the applicability of the invention so as to greatly improve the adaptability and competitiveness of the system.

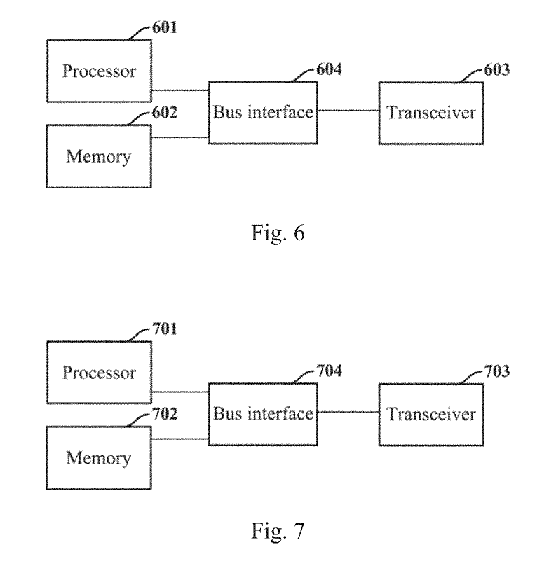

Based upon the same inventive idea, an embodiment of the invention further provides an intelligent terminal as illustrated in FIG. 6 generally includes a processor 601, a memory 602, a transceiver 603, and a bus interface 604, where the processor 601, the memory 602, and the transceiver 603 are connected via the bus interface 604.

The processor 601 is configured to read and execute program in the memory 602: to initiate a request for updating information about online friend-making, in an active pushing mode in which a user of the intelligent terminal initiates a request for making a friend, on his or her own initiative on an APP to request a friend-making back-end device for transmitting a list of friends or information about friends around the position where the user is located, and to update in real time the list of friends or the information about friends into the APP of the user.

The memory 602 is configured to store one or more executable program, and data for use by the processor 601 to perform the operations.

The transceiver 603 is configured to transmit and receive a radio signal under the control of the processor 601.

The bus interface 604 is configured to serve as an interface; and the processor is responsible for managing the bus architecture, and performing normal processes.

Here in FIG. 6, the bus architecture can include any number of interconnecting buses and bridges to particularly link together various circuits including one or more processors represented by the processor 601, and one or more memories represented by the memory 602.

The bus architecture can further link together various other circuits, e.g., a peripheral device, a manostat, a power management circuit, etc., all of which are well known in the art, so a further description thereof will be omitted in this context.

Preferably the processor 601 is further configured to initiate a request for updating information about online friend-making, in a passive pushing mode in which other than initiating by the user a request for updating information about online friend-making, on its own initiative, the APP performs polling periodically, requests a friend-making back-end device periodically for transmitting a list of friends or information about friends around the position where the user is located, and updates in real time the list of friends or the friend information into the APP of the user.

Based upon the same inventive idea, an embodiment of the invention further provides an APP back-end device as illustrated in FIG. 7 generally includes a processor 701, a memory 702, a transceiver 703, and a bus interface 704, where the processor 701, the memory 702, and the transceiver 703 are connected via the bus interface 704.

The processor 701 is configured to read and execute program in the memory 702: to receive service requests and feedback information of a user terminal transmitted by an intelligent terminal, to process the service requests, and to feed a result back to the intelligent terminal; and to transmit a part of the service requests of a user of the intelligent terminal to a friend-making back-end device so that the friend-making back-end device processes these service requests, and transmits a result of processing the requests to the intelligent terminal through the APP back-end device.

The memory 702 is configured to store one or more executable program, and data for use by the processor 701 to perform the operations.

The transceiver 703 is configured to receive requests and information transmitted by the intelligent terminal and the friend-making back-end device, and to transmit requests and information to the intelligent terminal and the friend-making back-end device, under the control of the processor 701.

The bus interface 704 is configured to serve as an interface, and the processor is responsible for managing the bus architecture, and performing normal processes.

Here in FIG. 7, the bus architecture can include any number of interconnecting buses and bridges to particularly link together various circuits including one or more processors represented by the processor 701, and one or more memories represented by the memory 702. The bus architecture can further link together various other circuits, e.g., a peripheral device, a manostat, a power management circuit, etc., all of which are well known in the art, so a further description thereof will be omitted in this context.

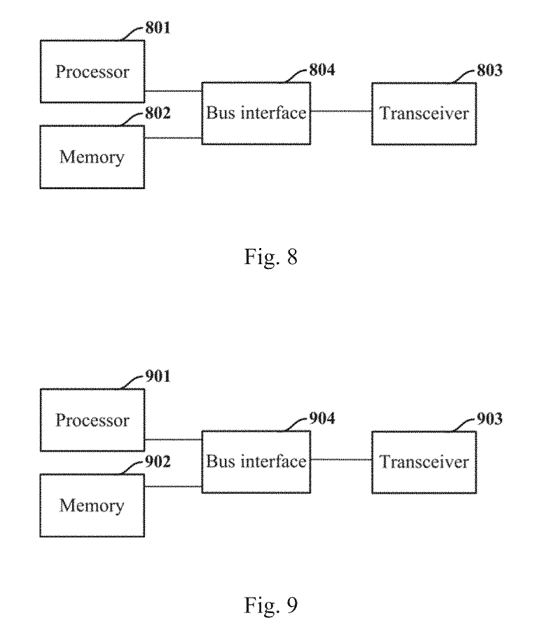

Based upon the same inventive idea, an embodiment of the invention further provides a friend-making back-end device as illustrated in FIG. 8 generally includes a processor 801, a memory 802, a transceiver 803, and a bus interface 804, where the processor 801, the memory 802, and the transceiver 803 are connected via the bus interface 804.

The processor 801 is configured to read and execute program in the memory 802: to make back-end large-data calculation and statistics according to request information of a list of friends, transmitted from an intelligent terminal, and positional information of a user obtained as a result of interaction between the intelligent terminal and an indoor positioning terminal, and to push the list of friends at the position where the user is located, into a list of APPs of the user of the intelligent terminal through an APP back-end device.

The memory 802 is configured to store one or more executable program, and data for use by the processor 801 to perform the operations.

The transceiver 803 is configured to receive requests and information transmitted by the APP back-end device, and to transmit requests and information to the APP back-end device, under the control of the processor 801.

The bus interface 804 is configured to serve as an interface, and the processor is responsible for managing the bus architecture, and performing normal processes.

Here in FIG. 8, the bus architecture can include any number of interconnecting buses and bridges to particularly link together various circuits including one or more processors represented by the processor 801, and one or more memories represented by the memory 802. The bus architecture can further link together various other circuits, e.g., a peripheral device, a manostat, a power management circuit, etc., all of which are well known in the art, so a further description thereof will be omitted in this context.

Based upon the same inventive idea, an embodiment of the invention further provides an indoor positioning terminal as illustrated in FIG. 9 generally includes a processor 901, a memory 902, a transceiver 903, and a bus interface 904, where the processor 901, the memory 902, and the transceiver 903 are connected via the bus interface 904.

The processor 901 is configured to read and execute program in the memory 902: to receive and measure a radio signal, to measure a received radio wave, to determine precisely a geographical position of some mobile terminal or moving person at some instance of time using some algorithm, and to position precisely an indoor user of an intelligent terminal according to pre-stored database and map information.

The memory 902 is configured to store one or more executable program, and data for use by the processor 901 to perform the operations.

The transceiver 903 is configured to receive a radio signal transmitted by the intelligent terminal under the control of the processor 901.

The bus interface 904 is configured to serve as an interface; and the processor is responsible for managing the bus architecture, and performing normal processes.

Here in FIG. 9, the bus architecture can include any number of interconnecting buses and bridges to particularly link together various circuits including one or more processors represented by the processor 901, and one or more memories represented by the memory 902. The bus architecture can further link together various other circuits, e.g., a peripheral device, a manostat, a power management circuit, etc., all of which are well known in the art, so a further description thereof will be omitted in this context.

Preferably the processor 901 is further configured: to be provided with an indoor positioning algorithm function, and to determine a precise indoor position of the user through calculation and making a decision using the algorithm according to field intensity information and fingerprint information of the terminal user, and stored map information.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in a form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. An information pushing system, comprising: an intelligent terminal sub-system, an indoor positioning sub-system, an APP server sub-system, and a friend-making server sub-system, wherein the intelligent terminal sub-system is connected with both the indoor positioning sub-system and the APP server sub-system, and the APP server sub-system is connected with the friend-making server sub-system.

2. The information pushing system according to claim 1, wherein the intelligent terminal sub-system has a function of transmitting and receiving a radio signal, and comprises an operating system platform on which an APP is installed.

3. The information pushing system according to claim 1, wherein the APP server sub-system is configured to receive service requests and feedback information of a user terminal transmitted by the intelligent terminal sub-system, to process the service requests, and to feed back a result to the intelligent terminal sub-system; and the APP server sub-system is also configured to transmit a part of the service requests of the user terminal of the intelligent terminal sub-system to the friend-making server sub-system, so that the friend-making server sub-system processes these service requests, and transmits results of processing these service requests to the user terminal of the intelligent terminal sub-system through the APP server sub-system.

4. The information pushing system according to claim 1, wherein the friend-making server sub-system is configured to make back-end large-data calculation and statistics, according to request information of a list of friends transmitted from the intelligent terminal sub-system, and positional information of a user obtained as a result of interaction between the intelligent terminal sub-system and the indoor positioning sub-system; and to push the list of friends at a position where the user is located, into a list of APPs of the user of the intelligent terminal sub-system through the APP server sub-system.

5. The information pushing system according to claim 1, wherein the indoor positioning sub-system is configured to receive and measure a radio signal, to measure a received radio wave, to determine precisely a geographical position of some mobile terminal or moving person at some instance of time using some algorithm, and to position precisely an indoor user of the intelligent terminal sub-system according to pre-stored database and map information.

6. The information pushing system according to claim 5, wherein the indoor positioning sub-system further comprises indoor positioning Access Points (Aps) and an indoor positioning server, wherein each indoor positioning AP is a small base station with a function of transmitting and receiving a radio signal, and generates, transmits, and receives a radio signal; and the indoor positioning server has an indoor positioning algorithm function, and determines a precise indoor position of the user through calculation and making a decision using the algorithm according to field intensity information and fingerprint information of the user, stored map information and a stored fingerprint information base.

7. A method for precise indoor positioning through interaction between the intelligent terminal sub-system and the indoor positioning sub-system in the information pushing system according to claim 1, the method comprising operations of:
(1) residing, by the intelligent terminal sub-system, in a cell of an indoor positioning Access Point (AP), and transmitting radio signal intensity information or fingerprint information to the indoor positioning AP;
(2) feeding, by the indoor positioning AP, the received radio signal intensity information or fingerprint information back to an indoor positioning server; and receiving, by the indoor positioning server, the radio signal intensity information or the fingerprint information fed back by a plurality of indoor positioning APs, processing the information using some technology and algorithm, and determining a precision position of a terminal user according to map information or fingerprint information stored on the server;
(3) transmitting, by the indoor positioning server, the determined precision position of the terminal user to the indoor positioning AP; and
(4) transmitting, by the indoor positioning AP, the determined precision position of the terminal user to the intelligent terminal sub-system, thus positioning the indoor terminal user precisely.

8. The method for precise indoor positioning according to claim 7, wherein an operating flow of the indoor positioning sub-system comprises operations of:
(1) storing, floor information of a specific building as a part of the map information into the indoor positioning server in a form of electronic map vector data;
(2) labeling, respective indoor positioning APs at respective floors individually; and
recording and storing label numbers of the respective APs into the indoor positioning server;
(3) when performing indoor positioning, obtaining, by the indoor positioning AP, residing information about the terminal user; and positioning the terminal user under a specific AP preliminarily using some technology and algorithm;
(4) transmitting, by the indoor positioning AP, positional information positioned preliminarily which comprises a label number corresponding to the indoor positioning AP, to the indoor positioning server; and
(5) mapping and matching, by the indoor positioning server, the positional information positioned preliminarily, and the label number of the indoor positioning AP, transmitted by the indoor positioning AP with the electronic map vector data in a database to thereby determine precisely the precision position of the terminal user, and outputting positional information of the terminal user to the intelligent terminal sub-system.

9. An information pushing method based upon precise indoor positioning in the information pushing system according to claim 1, comprising initiating, by a user terminal of the intelligent terminal sub-system, a request for updating information about online friend-making, in an active pushing mode in which the user terminal initiates a request for making a friend, on its own initiative, on an APP to request the friend-making server sub-system for transmitting a list of friends or information about friends around a position where a user of the user terminal is located, and updates in real time the list of friends or the information about friends into the APP of the user.

10. An information pushing method based upon precise indoor positioning in the information pushing system according to claim 1, comprising initiating, by a user terminal of the intelligent terminal sub-system, a request for updating information about online friend-making, in a passive pushing mode in which other than initiating by the user terminal a request for updating information about online friend-making, on its own initiative, an APP performs polling periodically, requests the friend-making server sub-system periodically for transmitting a list of friends or information about friends around a position where a user of the user terminal is located, and updates in real time the list of friends or the information about friends into the APP of the user.

11. The information pushing method according to claim 9, wherein an interaction flow in the active pushing mode comprises the following operations:
(1) transmitting, by the user terminal of the intelligent terminal sub-system, a positional information request carrying radio signal intensity information or fingerprint information of the terminal user to the indoor positioning sub-system on its own initiative;
(2) receiving, by the indoor positioning sub-system, the position request, and the radio signal intensity information or the fingerprint information, of the intelligent terminal sub-system, processing the request and the information using a positioning technology, outputting a precise geographical position of the terminal user, and transmitting the precise geographical position to the intelligent terminal sub-system;
(3) initiating, by the user terminal of the intelligent terminal sub-system, a request for updating information about online friend-making, which carries precise positional information of the terminal user, and transmitting the request, and the precise positional information of the terminal user to the APP server sub-system;
(4) transmitting, by the APP server sub-system, the request for updating information about online friend-making, initiated from the user terminal of the intelligent terminal sub-system on its own initiative, and the precise positional information of the terminal user, to the friend-making server sub-system;
(5) making, by the friend-making server sub-system, back-end large-data calculation and statistics, and transmitting a list of friends at the position where the user is located, to the APP server sub-system; and
(6) receiving, by the APP server sub-system, the list of friends at the position where the user is located, transmitted from the friend-making server sub-system, transmitting the list of friends at the position where the user is located to the intelligent terminal sub-system, and updating in real time the information into the APP of the user.

12. The information pushing method according to claim 10, wherein an interaction flow in the passive pushing mode comprises following operations:
(1) transmitting, by the user terminal of the intelligent terminal sub-system, a positional information request carrying radio signal intensity information or fingerprint information of the terminal user to the indoor positioning sub-system on its own initiative;
(2) receiving, by the indoor positioning sub-system, the position request, and the radio signal intensity information or the fingerprint information, of the intelligent terminal sub-system, processing the request and the information using a positioning technology, outputting a precise geographical position of the terminal user, and transmitting the precise geographical position to the intelligent terminal sub-system;
(3) initiating, by the user terminal of the intelligent terminal sub-system, a request for updating information about online friend-making, which carries precise positional information of the terminal user, and transmitting the request, and the precise positional information of the terminal user to the APP server sub-system;
(4) transmitting, by the APP server sub-system, the request for updating information about online friend-making, initiated from the user terminal of the intelligent terminal sub-system on its own initiative, and the precise positional information of the terminal user, to the friend-making server sub-system;
(5) making, by the friend-making server sub-system, back-end large-data calculation and statistics, and transmitting a list of friends at the position where the user is located, to the APP server sub-system; and
(6) receiving, by the APP server sub-system, the list of friends at the position where the user is located, transmitted from the friend-making server sub-system, transmitting the list of friends at the position where the user is located to the intelligent terminal sub-system, and updating in real time the information into the APP of the user.

13. An intelligent terminal, comprising: a processor, a memory, a transceiver, and a bus interface, wherein the processor, the memory, and the transceiver are connected via the bus interface;
the processor is configured to read and execute program in the memory: to initiate a request for updating information about online friend-making, in an active pushing mode in which the intelligent terminal initiates a request for making a friend, on his or her own initiative, on an APP to request a friend-making back-end device for transmitting a list of friends or information about friends around the position where the user is located, and to update in real time the list of friends or the information about friends into the APP of a user of the intelligent terminal;
the memory is configured to store one or more executable program, and data for use by the processor to perform operations;
the transceiver is configured to transmit and receive a radio signal under the control of the processor; and
the bus interface is configured to serve as an interface.

14. The intelligent terminal according to claim 13, wherein the processor is further configured:
to initiate a request for updating information about online friend-making, in a passive pushing mode in which other than initiating by the user a request for updating information about online friend-making, on its own initiative, the APP performs polling periodically, requests a friend-making back-end device periodically for transmitting a list of friends or information about friends around the position where the user is located, and updates in real time the list of friends or the friend information into the APP of the user.

15-16. (canceled)

17. An indoor positioning terminal, comprising: a processor, a memory, a transceiver, and a bus interface, wherein the processor, the memory, and the transceiver are connected via the bus interface;
the processor is configured to read and execute program in the memory: to receive and measure a radio signal, to measure a received radio wave, to determine precisely a geographical position of some mobile terminal or moving person at some instance of time using some algorithm, and to position precisely an indoor user of an intelligent terminal according to pre-stored database and map information;
the memory is configured to store one or more executable program, and data for use by the processor to perform the operations;
the transceiver is configured to receive the radio signal transmitted by the intelligent terminal under the control of the processor; and
the bus interface is configured to serve as an interface.

18. The indoor positioning terminal according to claim 17, wherein the processor is further configured:
to be provided with an indoor positioning algorithm function, and to determine a precise indoor position of the user through calculation and making a decision using the algorithm according to field intensity information and fingerprint information of the terminal user, and stored map information.
